(19) United States
(12) Patent Application Publication
(10) Pub. No.: US 2026/0300711 A1
(43) Pub. Date: Oct. 1, 2026

(54) CHIP SYSTEM FOR TRAINING LARGE MODEL FOR INTELLIGENT OPTICAL COMPUTING, COMPUTING METHOD, AND ELECTRONIC DEVICE

(71) Applicant: TSINGHUA UNIVERSITY, BEIJING (CN)

(72) Inventors: LU FANG, BEIJING (CN); ZHIWEI XUE, BEIJING (CN)

(21) Appl. No.: 19/286,193

(22) Filed: Jul. 30, 2025

(30) Foreign Application Priority Data
Mar. 28, 2025 (CN) 202510379732.4

(51) Int. Cl. G06N 3/067; G06E 3/00

(52) U.S. Cl. CPC G06N 3/0675; G06E 3/003

(57) ABSTRACT

A chip system for training a large model for intelligent optical computing includes a plurality of optical chips, each of which includes: digital-to-analog converters (DACs), configured to convert digital electrical signals of input parameters into first analog electrical signals of the input parameters, and convert digital electrical signals of variable parameters into second analog electrical signals of the variable parameters; on-chip attenuators, connected to the DACs, configured to convert the first analog electrical signals into first analog optical signals, convert the second analog electrical signals into second analog optical signals, and obtain multiplication results by multiplying the input parameters in the first analog optical signals with the variable parameters in the second analog optical signals; and a summation module, configured to obtain a target output result by summing the multiplication results.

### CROSS-REFERENCE TO RELATED PATENT APPLICATION

This application claims priority to Chinese Patent Application No. 202510379732.4, filed on Mar. 28, 2025, the entire content of which is incorporated by reference herein.

### FIELD OF THE DISCLOSURE

The disclosure relates to the field of optical computing technology, and in particular to a chip system for training a large model for intelligent optical computing, a computing method and an electronic device.

### BACKGROUND OF THE DISCLOSURE

Based on the development of deep learning and large model, the complexity and scale of computational demands during large model training processes continue to increase. However, existing electronic computing architectures face high power consumption and computational latency when processing large-scale parallel computing tasks, making it difficult to effectively meet the increasingly stringent requirements for computing power and energy efficiency in large models. In this case, optical computing uses photons for information transmission and information processing, offering ultra-high speed and low energy consumption advantages. Based on this, optical computing technology that uses photons replacing electrons as computational carriers is regarded as the key to breaking through existing computational bottlenecks.

### SUMMARY OF THE DISCLOSURE

According to a first aspect of the disclosure, a chip system for training a large model for intelligent optical computing includes a plurality of optical chips, in which each optical chip includes: a plurality of digital-to-analog converters (DACs), configured to convert digital electrical signals of a plurality of input parameters to be calculated into first analog electrical signals of the plurality of input parameters to be calculated, and convert digital electrical signals of a plurality of variable parameters to be calculated into second analog electrical signals of the plurality of variable parameters to be calculated; a plurality of on-chip attenuators, connected to the plurality of DACs, configured to convert the first analog electrical signals into first analog optical signals, convert the second analog electrical signals into second analog optical signals, and obtain a plurality of multiplication results by multiplying the plurality of input parameters in the first analog optical signals with the plurality of variable parameters in the second analog optical signals; and a summation module, configured to obtain a target output result by summing the plurality of multiplication results.

According to a second aspect of the disclosure, a computing method for the chip system for training a large model for intelligent optical computing includes: converting digital electrical signals of a plurality of input parameters to be calculated into first analog electrical signals of the plurality of input parameters to be calculated, and converting digital electrical signals of a plurality of variable parameters to be calculated into second analog electrical signals of the plurality of variable parameters to be calculated, via a plurality of DACs included in the system; converting the first analog electrical signals into first analog optical signals, converting the second analog electrical signals into second analog optical signals, and obtaining a plurality of multiplication results by multiplying the plurality of input parameters in the first analog optical signals with the plurality of variable parameters in the second analog optical signals, via a plurality of on-chip attenuators connected to the plurality of DACs included in the system; and obtaining a target output result by summing the plurality of multiplication results.

According to a third aspect of the disclosure, an electronic device includes: a processor; and a memory communicatively coupled to the processor and storing instructions executable by the processor; in which when the instructions are executed by the processor, the processor is caused to perform the method according to the above first aspect.

### BRIEF DESCRIPTION OF THE DRAWINGS

The above-mentioned and/or additional aspects and advantages of the disclosure will become apparent and readily appreciated from the following description of embodiments, taken in combination with the accompanying figures.

FIG. 1 is a schematic diagram illustrating a structure of a chip system for training a large model for intelligent optical computing provided in an embodiment of the disclosure.

FIG. 2 is a schematic diagram illustrating a structure of a summation module provided in an embodiment of the disclosure.

FIG. 3 is a flow chart illustrating a computing method for the chip system for training a large model for intelligent optical computing provided in an embodiment of the disclosure.

FIG. 4 is a block diagram illustrating an electronic device according to some embodiments of the present disclosure.

### DETAILED DESCRIPTION OF THE EXEMPLARY EMBODIMENTS

Embodiments of the disclosure are described in detail below, and examples of the embodiments are illustrated in the accompanying figures, in which the same or similar symbols from beginning to end indicate the same or similar elements. The embodiments described below by reference to the accompanying figures are exemplary and are intended to be used to explain the disclosure and are not to be construed as a limitation of the disclosure.

The following describes the disclosure in detail with reference to specific embodiments.

The chip system for training a large model for intelligent optical computing and the computing method provided in the disclosure achieve photonic processing of computational tasks through a plurality of optical chips by fully utilizing high-speed parallel processing characteristics of photons, and thus improve the efficiency and throughput of model training.

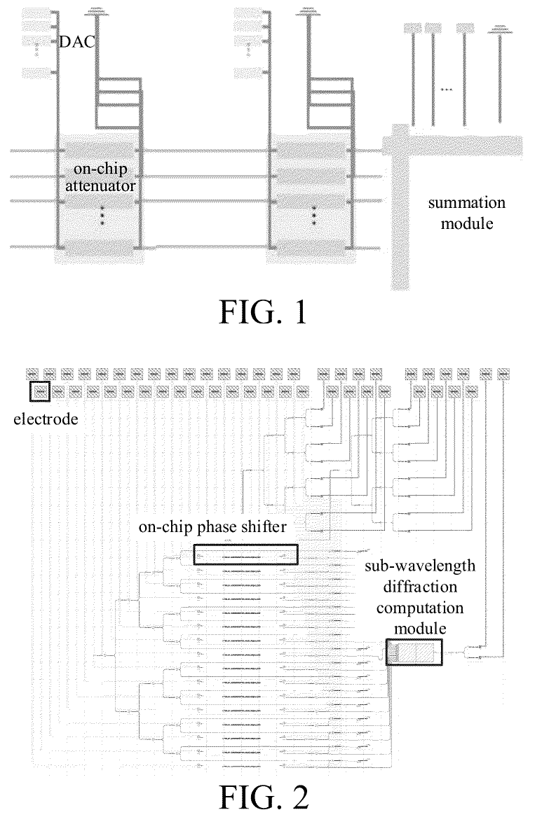

FIG. 1 is a schematic diagram illustrating a structure of a chip system for training a large model for intelligent optical computing provided in an embodiment of the disclosure. As shown in FIG. 1, the system includes a plurality of digital-to-analog converters (DACs), a plurality of on-chip attenuators and a summation module. In an example, the system may be configured or integrated or included in an electronic device.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another. A unit or module may be implemented purely by software, purely by hardware, or by a combination of hardware and software. In a pure software implementation, for example, the unit or module may include functionally related code blocks or software components, that are directly or indirectly linked together, so as to perform a particular function.

The plurality of digital-to-analog converters (DACs) are configured to convert digital electrical signals of a plurality of input parameters to be calculated into analog electrical signals, and convert digital electrical signals of a plurality of variable parameters to be calculated into analog electrical signals.

The plurality of on-chip attenuators are connected to the plurality of DACs, configured to convert the analog electrical signals of the plurality of input parameters to be calculated into analog optical signals, convert the analog electrical signals of the plurality of variable parameters to be calculated into analog optical signals, and obtain a plurality of multiplication results by multiplying the plurality of input parameters with the plurality of variable parameters in the analog optical signals.

The summation module is configured to obtain a target output result by summing the plurality of multiplication results.

In an embodiment of the disclosure, the large model may be applied to various scenarios, for example, an intelligent question-answering scenario.

In an embodiment of the disclosure, a trainable unit in the large model is a multi-layer perceptron layer, and parameters in remaining network layers of the large model may directly participate in computation without training. Based on this, in the embodiment of the disclosure, the system may include a plurality of optical chips to replace the multi-layer perceptron layer via the plurality of optical chips.

For example, in an embodiment of the disclosure, assuming that a multi-layer perceptron layer with an input of N×N is transformed into a combination of N optical module layers such that the combination is completely equivalent to a conventional multi-layer perceptron. Based on this, complete training of the multi-layer perceptron layer may be accomplished by training N combined optical module layers. Thus, a computational structure of one optical module layer may be implemented by the optical chip, such that efficient optical training of the large model may be achieved by executing model training on the chip.

In an embodiment of the disclosure, each on-chip attenuator in a part of the plurality of on-chip attenuators is configured to convert the analog electrical signals of the input parameters to be calculated into the analog optical signals; each on-chip attenuator in another part of the plurality of on-chip attenuators is configured to convert the analog electrical signals of variable parameters into the analog optical signals; and each input parameter has a corresponding variable parameter.

Specifically, in an embodiment of the disclosure, a quantity of the on-chip attenuators for loading input parameters and a quantity of the on-chip attenuators for loading variable parameters are related to a computational scale of the optical module layer. Specifically, in an embodiment of the disclosure, if the optical module layer is N×N, that is, y=Aᵢ (mᵢ·x), 2N on-chip attenuators are required at this time, in which N on-chip attenuators are for loading input parameters to be calculated, and N on-chip attenuators are for loading variable parameters corresponding to the input parameters. Each on-chip attenuator for the input parameter is cascaded with each on-chip attenuator for the variable parameter to accomplish a multiplication operation mᵢ·x. The input parameter or variable parameter in each attenuator is provided via a plurality of DACs.

In an embodiment of the disclosure, after obtaining outputs of the multiplication operation via the plurality of on-chip attenuators, a target output result may be obtained by summing the plurality of multiplication results via the summation module.

Specifically, in an embodiment of the disclosure, to implement a matrix operation with a matrix Aᵢ an input, in which

$${A}_{i} = [ \begin{matrix}1 & 1 & … & 1 \\ 1 & 0 & … & 0 \\ … & … & … & … \\ 1 & 0 & … & 0\end{matrix} ] ,$$

elements in the i-th row and i-th column are all 1, and remaining elements are 0. FIG. 2 is a schematic diagram illustrating a structure of a summation module provided in an embodiment of the disclosure. As shown in FIG. 2, the summation module may include a plurality of on-chip phase shifters and a sub-wavelength diffraction computation module. The summation module ensures an input phase uniformity via the plurality of on-chip phase shifters, and effectively modulates and manipulates light on the chips via the sub-wavelength diffraction computation module.

A quantity of the on-chip phase shifters is related to an output parameter dimension of the on-chip attenuators. For example, if an output parameter dimension of the on-chip attenuators is N, the summation module includes N on-chip phase shifters, in which the N on-chip phase shifters ensure input phase uniformity and eliminate phase errors from off-chip light propagation. Further, the on-chip sub-wavelength diffraction structure is an optical structure based on nanoscale feature dimensions, capable of effectively modulating and manipulating light on the chip. The parameters of the on-chip sub-wavelength diffraction structure are loaded on air grooves of different lengths on a planar waveguide; under fixed width and spacing, a phase change of light passing through the sub-wavelength diffraction structure relates only to the length of the on-chip sub-wavelength diffraction structure.

Further, in an embodiment of the disclosure, parameters in the sub-wavelength diffraction computation module are pre-trained, and the sub-wavelength diffraction computation module is configured to implement a summation operation with a plurality of inputs and a single output. For example, if a parameter dimension of the on-chip attenuators is N, the sub-wavelength diffraction computation module may implement a summation operation with N inputs and one output. In addition, an output path for one of the N inputs is equally divided into N−1 optical paths on the waveguide as remaining output ports. Thus, the optical chip may implement an efficient N-to-N optical summation module.

Further, in an embodiment of the disclosure, an activation propagation operation may be implemented via the above structure of the optical chip, and N optical chips may implement a complete training process of an N×N multi-layer perceptron. The plurality of optical chip modules may be integrated onto a complete printed circuit board (PCB) panel to constitute a basic unit for optical training of the large model. By efficiently reusing the basic unit via high-efficiency digital-to-analog conversion and analog-to-digital conversion, high-speed and high-energy-efficiency optical training of the large model may be implemented.

Further, in an embodiment of the disclosure, each optical chip guides light entering and exiting the optical chip through a plurality of eight-channel fiber arrays (for example, two) with a period of 127 μm and a tilt angle of 8°, thus implementing an efficient and stable chip operating system. After aligning fiber arrays and grating arrays under a microscope using a nanoscale electric displacement stage, the vertically coupled fiber arrays are fixed on a photonic integrated circuit (PIC) with curable epoxy resin; after packaging, a coupling insertion loss from fiber to chip is approximately-8 dB per channel.

In an embodiment of the disclosure, the optical chip may further include two layers of dedicated PCBs for electrical signal feeding on the optical chip. Further, chip pads on a variable optical attenuator (VOA) array with a pitch of 100 μm are connected to the PCB via gold wire bonding, and independently routed to electrical sockets via signal lines with an 800 μm pitch. A customized multi-channel direct current signal source is connected to the board. By setting a voltage of 0-5V to control an injection current of the VOA, an imaginary part of an effective refractive index of a guided mode is effectively adjusted.

Further, in an embodiment of the disclosure, each optical chip and a thermistor are mounted on a copper block, a thermoelectric cooler (TEC) (Peltier cooler) is attached to the copper block, in which the thermistor is configured to measure a temperature of each optical chip to cool the packaged system. The thermistor and the TEC form a proportional-integral-derivative (PID) feedback loop, configured to maintain the temperature of each optical chip within a preset range. In an embodiment of the disclosure, the preset range may be within +0.004 Kelvin, corresponding to a long-term resistance stability of the thermistor of +2 ohms, thus ensuring reliable and consistent operation of the system.

In the chip system for training a large model for intelligent optical computing according to the embodiments of the disclosure, high-speed and high-energy-efficiency optical training of the large model may be supported via the optical chips, significantly improving efficiency and throughput of model training, with broad application prospects, providing a novel efficient and green solution for artificial intelligence large model training.

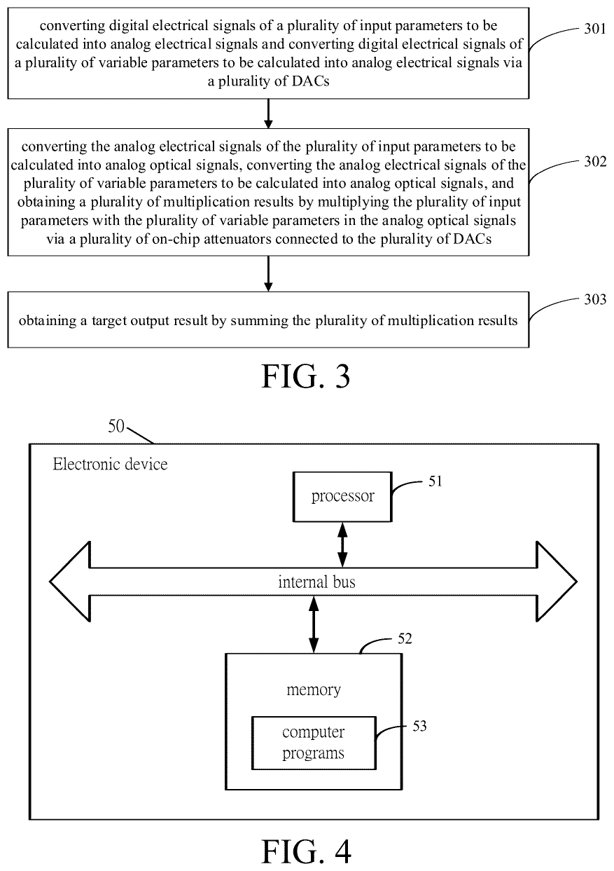

To implement the above embodiments, FIG. 3 is a flow chart illustrating a computing method for the chip system for training a large model for intelligent optical computing provided in an embodiment of the disclosure. The method may include the following steps 301 to 303.

At step 301, digital electrical signals of a plurality of input parameters to be calculated are converted into analog electrical signals and digital electrical signals of a plurality of variable parameters to be calculated are converted into analog electrical signals via a plurality of DACs.

At step 302, the analog electrical signals of the plurality of input parameters to be calculated are converted into analog optical signals, the analog electrical signals of the plurality of variable parameters to be calculated are converted into analog optical signals, and a plurality of multiplication results are obtained by multiplying the plurality of input parameters with the plurality of variable parameters in the analog optical signals via a plurality of on-chip attenuators connected to the plurality of DACs.

At step 303, a target output result is obtained by summing the plurality of multiplication results.

In an embodiment of the disclosure, converting the analog electrical signals of the plurality of input parameters to be calculated into the analog optical signals, converting the analog electrical signals of the plurality of variable parameters to be calculated into the analog optical signals, and obtaining the plurality of multiplication results by multiplying the plurality of input parameters with the plurality of variable parameters in the analog optical signals via the plurality of on-chip attenuators connected to the plurality of DACs includes: converting the analog electrical signals of the input parameters to be calculated into the analog optical signals via each on-chip attenuator in a part of the plurality of on-chip attenuators; converting the analog electrical signals of variable parameters into the analog optical signals via each on-chip attenuator in another part of the plurality of on-chip attenuators; and obtaining the plurality of multiplication results by multiplying the signals, in which each input parameter has a corresponding variable parameter.

FIG. 4 is a block diagram illustrating an electronic device 50 according to an example embodiment of the present disclosure. The electronic device 50 includes a processor 51 and a memory 52. The memory 52 is configured to store executable instructions. The memory 52 includes computer programs 53. The processor 51 is configured to execute blocks of the above-mentioned method.

The processor 51 is configured to execute the computer programs 53 included in the memory 52. The processor 51 may be a central processing unit (CPU) or another a general-purpose processor, a digital signal processor (DSP), an application specific integrated circuit (ASIC), a field-programmable gate array (FPGA), another programmable logic device, a discrete gate, a transistor logic device, a discrete hardware component, and the like. The general-purpose processor may be a microprocessor or any conventional processor. In the embodiments of the disclosure, the processor may control the DACs and the on-chip attenuators to perform their respective functions, and may implement the functions of the summation module, when the instructions in the memory are executed by the processor.

The memory 52 is configured to store computer programs related to the method. The memory 52 may include at least one type of storage medium. The storage medium includes a flash memory, a hard disk, a multimedia card, a card-type memory (such as, a SD (secure digital) or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disk, etc. The device may cooperate with a network storage device that performs a storage function of the memory by a network connection. The memory 52 may be an internal storage unit of the electronic device 50, such as a hard disk or a memory of the electronic device 50. The memory 52 may also be an external storage device of the electronic device 50, such as a plug-in hard disk, a smart media card (SMC), a secure digital (SD) card, a flash card, disposed on the electronic device 50. Further, the memory 52 may also include both the internal storage unit of the electronic device 50 and the external storage device. The memory 52 is configured to store the computer program 53 and other programs and data required by the device. The memory 52 may also be configured to temporarily store data that has been output or will be output.

The various embodiments described herein may be implemented by using the computer readable medium such as computer software, hardware, or any combination thereof. For a hardware implementation, embodiments described herein may be implemented by using at least one of: an application specific integrated circuit (ASIC), a digital signal processor (DSP), a digital signal processing device (DSPD), a programmable logic device (PLD), a field programmable gate array (FPGA), a processor, a controller, a microcontroller, a microprocessor, and an electronic unit designed to perform the functions described herein. For a software implementation, an implementation such as a procedure or a function may be implemented with a separate software module that allows at least one function or operation to be performed. Software codes may be implemented by a software application (or program) written in any suitable programming language, and the software codes may be stored in the memory and executed by the controller.

The electronic device 50 includes, but is not limited to, a mobile terminal, an ultra-mobile personal computer device, a server, and other electronic device with a computing function. (1) The mobile terminal is characterized by having a function of mobile communication and aiming at providing a voice and data communication. Such mobile terminal includes a smart phone (such as iPhone), a multimedia phone, a functional phone, and a low-end phone. (2) The ultra-mobile personal computer device belongs to a category of personal computer, which has a computing and processing function, and generally has a feature of mobile Internet access. Such terminal includes a PDA (personal digital assistant), a MID (mobile Internet device) and a UMPC (ultra mobile personal computer) devices, such as an iPad. (3) The server provides a computing service. A composition of the server includes a processor, a hard disk, a memory, a system bus, etc. The server is similar to the general computer architecture, but because the server only provides a highly reliable service, it requires a higher processing capacity, stability, reliability, security, scalability and manageability. (4) Other electronic device with the computing function may include, but be not limited to, the processor 51 and the memory 52. It may be understood by the skilled in the art that, FIG. 4 is merely an example of the electronic device 50, and does not constitute a limitation of the electronic device 50. The electronic device 50 may include more or less components than illustrated, some combined components, or different components. For example, the electronic device may also include an input device, an output device, a network access device, a bus, a camera device, etc.

The implementation procedure of the functions of each unit in the above electronic device may refer to the implementation procedure of the corresponding actions in the above method, which is not elaborated here.

In some embodiment, there is also provided a storage medium including instructions, such as the memory 52 including instructions. The above instructions may be executed by the processor 51 of the electronic device 50 to perform the above method. In some embodiments, the storage medium may be a non-transitory computer readable storage medium. For example, the non-transitory computer readable storage medium may include a ROM, a RAM, a compact disc read-only memory (CD-ROM), a magnetic tape, a floppy disk, optical data storage device, etc.

A non-transitory computer readable storage medium is provided. When instructions stored in the storage medium are executed by an electronic device, the electronic device is enabled to execute the above method.

In some embodiments, there is also provided a computer program product including executable program codes. The program codes are configured to execute any of the above embodiments of the method when executed by the above electronic device.

In the disclosure, processing including collection, storage, use, shaping, transmission, provision and disclosure of the personal information of the user is in compliance with the provisions of relevant laws and regulations, and does not violate public order and moral.

It should be noted that personal information from users should be collected for a legitimate and reasonable purpose, and should not be shared or sold beyond these legitimate uses. In addition, such collection/sharing should be carried out after receiving an informed consent from the user, including but not limited to, notifying the user to read a user agreement/user notification and sign an agreement/authorization that includes an authorization of relevant user information before using this function. In addition, necessary steps should be taken to safeguard an access to such personal information data, and to ensure that others who have the right to access the personal information data comply with a privacy policy and procedures.

The disclosure is expected to provide an implementation plan for the user to selectively block the use or access of the personal information data, that is, the disclosure is intended to provide hardware and/or software to prevent or block access to the personal information data. Once the personal information data is no longer needed, limiting data collection and deleting data may minimize risks. In addition, when applicable, a personal identifier should be removed from the personal information to protect a privacy of the user.

Acquisition, transmission, storage, use, and processing of data in the technical solution of the disclosure comply with relevant regulations in national laws.

It should be noted that in the embodiments of the disclosure, some software, components, models, and other existing solutions in the industry may be mentioned, which should be considered as exemplary. The purpose is only to illustrate a feasibility of the technical solution in the application, but it does not mean that the applicant has already or necessarily used the solution.

In the descriptions of the above embodiments, terms such as “an embodiment,” “some embodiments,” “an example,” “a specific example,” or “some examples,” means that a particular feature, structure, material, or characteristic described in connection with the embodiment or example is included in at least one embodiment or example of the disclosure. Thus, the appearances of the above terms in various places throughout this specification are not necessarily referring to the same embodiment or example of the disclosure. Furthermore, the particular features, structures, materials, or characteristics may be combined in any suitable manner in one or more embodiments or examples. In addition, without contradicting each other, those skilled in the art may combine and combine different embodiments or examples and features of different embodiments or examples described in this specification.

Additionally, the terms “first” and “second” are used for descriptive purposes only and are not to be construed as indicating or implying relative importance or implicitly specifying the number of technical features indicated. Thus, a feature defined with the terms “first”, “second” may expressly or impliedly include at least one such feature. In the description of the disclosure, “plurality” means at least two, such as two, three, etc., unless otherwise expressly and specifically limited.

Any process or method description depicted in the flow chart or otherwise described herein may be understood to represent a module, fragment, or portion of code including one or more executable instructions configured to implement the steps of a customized logic function or process. The scope of the preferred embodiments of this disclosure includes alternative implementations where the functions may be executed in a different order than shown or discussed. This may include executing functions simultaneously or in the reverse order based on the specific functionality involved. This should be understood by those skilled in the art related to the technical field of the disclosed embodiments.

The logic and/or step described in other manners herein or shown in the flowchart, for example, a particular sequence table of executable instructions for realizing the logical function, may be specifically achieved in any computer readable medium to be used by the instruction execution system, device or equipment (such as the system based on computers, the system including processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium include but are not limited to: an electronic connection (an electronic device) with one or more wires, a portable computer enclosure (a magnetic device), a RAM, a ROM, an EPROM or a flash memory, an optical fiber device and a CD-ROM. In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a PGA, a FPGA, etc.

It may be understood by those skilled in the art that all or a part of the steps carried by the method in the above-described embodiments may be completed by relevant hardware instructed by a program. The program may be stored in a computer readable storage medium. When the program is executed, one step or a combination of the steps of the method in the above-described embodiments may be completed.

In addition, individual functional units in the embodiments of the disclosure may be integrated in one processing module or may be physically separated, or two or more units may be integrated in one module. The integrated module as described above may be achieved in the form of hardware, or may be achieved in the form of a software functional module. If the integrated module is achieved in the form of a software functional module and sold or used as a separate product, the integrated module may also be stored in a computer readable storage medium.

The storage medium mentioned above may be ROMs, magnetic disks or CD, etc. Although explanatory embodiments have been shown and described, it would be appreciated by those skilled in the art that the above embodiments are exemplary and are not to be construed as limiting the disclosure, and changes, modifications, alternatives, and modifications can be made in the embodiments without departing from scope of the disclosure.

What is claimed is:

1. A chip system for training a large model for intelligent optical computing, the chip system comprising a plurality of optical chips, wherein each optical chip comprises:
a plurality of digital-to-analog converters (DACs), configured to convert digital electrical signals of a plurality of input parameters to be calculated into first analog electrical signals of the plurality of input parameters to be calculated, and convert digital electrical signals of a plurality of variable parameters to be calculated into second analog electrical signals of the plurality of variable parameters to be calculated;
a plurality of on-chip attenuators, connected to the plurality of DACs, configured to convert the first analog electrical signals into first analog optical signals, convert the second analog electrical signals into second analog optical signals, and obtain a plurality of multiplication results by multiplying the plurality of input parameters in the first analog optical signals with the plurality of variable parameters in the second analog optical signals; and
a summation module, configured to obtain a target output result by summing the plurality of multiplication results.

2. The system according to claim 1, wherein the summation module comprises a plurality of on-chip phase shifters and a sub-wavelength diffraction computation module,
the summation module ensures an input phase uniformity via the plurality of on-chip phase shifters, and effectively modulates and manipulates light on the optical chips via the sub-wavelength diffraction computation module.

3. The system according to claim 2, wherein parameters in the sub-wavelength diffraction computation module are pre-trained, and the sub-wavelength diffraction computation module is configured to implement a summation operation with a plurality of inputs and a single output.

4. The system according to claim 1, wherein each on-chip attenuator in a part of the plurality of on-chip attenuators is configured to convert the first analog electrical signals into the first analog optical signals; each on-chip attenuator in another part of the plurality of on-chip attenuators is configured to convert the second analog electrical signals into the second analog optical signals; and each input parameter has a corresponding variable parameter.

5. The system according to claim 1, wherein each optical chip guides light entering and exiting the optical chip through a plurality of eight-channel fiber arrays with a period of 127 μm and a tilt angle of 8°.

6. The system according to claim 1, wherein the plurality of optical chips are integrated onto a complete printed circuit board (PCB) panel.

7. The system according to claim 1, wherein each optical chip and a thermistor are mounted on a copper block, a thermoelectric cooler (TEC) is attached to the copper block, wherein the thermistor is configured to measure a temperature of each optical chip.

8. The system according to claim 7, wherein the thermistor and the TEC form a proportional-integral-derivative (PID) feedback loop, configured to maintain the temperature of each optical chip within a preset range.

9. A computing method for a chip system for training a large model for intelligent optical computing, the method comprising:
converting digital electrical signals of a plurality of input parameters to be calculated into first analog electrical signals of the plurality of input parameters to be calculated, and converting digital electrical signals of a plurality of variable parameters to be calculated into second analog electrical signals of the plurality of variable parameters to be calculated, via a plurality of digital-to-analog converters (DACs) comprised in the system;
converting the first analog electrical signals into first analog optical signals, converting the second analog electrical signals into second analog optical signals, and obtaining a plurality of multiplication results by multiplying the plurality of input parameters in the first analog optical signals with the plurality of variable parameters in the second analog optical signals, via a plurality of on-chip attenuators connected to the plurality of DACs comprised in the system; and
obtaining a target output result by summing the plurality of multiplication results.

10. The method according to claim 9, wherein obtaining the plurality of multiplication results comprises:
converting the first analog electrical signals into the first analog optical signals, via each on-chip attenuator in a part of the plurality of on-chip attenuators;
converting the second analog electrical signals into the second analog optical signals, via each on-chip attenuator in another part of the plurality of on-chip attenuators; and
obtaining the plurality of multiplication results by multiplying the first and second analog optical signals,
wherein each input parameter has a corresponding variable parameter.

11. An electronic device, comprising a processor and a memory storing instructions executable by the processor, wherein when the instructions are executed by the processor, the processor is configured to:
control a plurality of digital-to-analog converters (DACs) comprised in the system to convert digital electrical signals of a plurality of input parameters to be calculated into first analog electrical signals of the plurality of input parameters to be calculated and convert digital electrical signals of a plurality of variable parameters to be calculated into second analog electrical signals of the plurality of variable parameters to be calculated;
control a plurality of on-chip attenuators connected to the plurality of DACs comprised in the system to convert the first analog electrical signals into first analog optical signals, convert the second analog electrical signals into second analog optical signals, and obtain a plurality of multiplication results by multiplying the plurality of input parameters in the first analog optical signals with the plurality of variable parameters in the second analog optical signals;
obtain a target output result by summing the plurality of multiplication results.

12. The electronic device according to claim 11, wherein the processor is further configured to control each on-chip attenuator in a part of the plurality of on-chip attenuators to convert the first analog electrical signals into the first analog optical signals;
control each on-chip attenuator in another part of the plurality of on-chip attenuators to convert the second analog electrical signals into the second analog optical signals; and
obtain the plurality of multiplication results by multiplying the first and second analog optical signals,
wherein each input parameter has a corresponding variable parameter.
